(19) United States
(12) Patent Application Publication
(10) Pub. No.: US 2025/0383617 A1
(43) Pub. Date: Dec. 18, 2025

(54) FIXING DEVICE

(71) Applicant: CANON KABUSHIKI KAISHA, Tokyo (JP)

(72) Inventors: KIYONORI SOTOME, Ibaraki (JP); YASUHARU TORATANI, Chiba (JP); SUGURU TAKEUCHI, Chiba (JP); HIROSHI MIYAMOTO, Saitama (JP); KENGO KOYAMA, Chiba (JP); AKIYOSHI SHINAGAWA, Saitama (JP); AYANO SAITO, Chiba (JP); MASAKI SUDA, Chiba (JP); TATSUO YASUI, Tokyo (JP); TAKUYA HASEGAWA, Tokyo (JP); RIKIYA TAKEMASA, Chiba (JP); TOMOYUKI KURIYAMA, Tokyo (JP); MASAKI FURUTANI, Chiba (JP); TAKESHI KOZUMA, Ibaraki (JP); KENICHI TANAKA, Ibaraki (JP)

(21) Appl. No.: 19/204,786

(22) Filed: May 12, 2025

(30) Foreign Application Priority Data
Jun. 12, 2024 (JP) 2024-095147

(51) Int. Cl. G03G 15/20

(52) U.S. Cl. CPC G03G 15/2053; G03G 15/2064; G03G 2215/2038

(57) ABSTRACT

A fixing device for heating a toner image on a recording material includes an endless belt, a rotatable member, a pad disposed inside the belt so as to nip the belt between the pad and the rotatable member, and first and second stretching rollers in contact with an inner peripheral surface of the belt. The second stretching member is disposed in a downstream side of the first stretching roller and an upstream side of the pad with respect to a rotational direction of the belt. A heater heats the belt by heating the second stretching roller. A lubricant applying member is in contact with the inner peripheral surface of the belt in the downstream side of the first stretching roller and an upstream side of the second stretching roller with respect to the rotational direction, and applies a lubricant to the inner peripheral surface of the belt.

### BACKGROUND

### Field of the Technology

The present disclosure relates to a fixing device which fixes a toner image carried on a recording material to the recording material.

### Description of the Related Art

An image forming apparatus such as a copy machine, a printer, a facsimile machine, and a multifunction machine which has a plurality of functions thereof includes the fixing device which fixes the toner image carried on the recording material to the recording material. As the fixing device, a configuration in which the toner image on the recording material is conveyed while heated in a nip portion formed by an endless belt member and a rotatable member has been conventionally known (Patent document 1).

A fixing device described in Japanese Patent Application Laid-Open No. 2023-77275 forms a nip portion using a nip portion forming member which nips a belt member between itself and a rotatable member. In a case in which the nip portion is formed using such nip portion forming member, it is known that image defect occurs and/or an inner surface of the belt is scraped due to sliding resistance between the belt member and the nip portion forming member being increased in the nip portion. For this reason, a configuration in which, by applying a lubricant to an inner peripheral surface of the belt member, the sliding resistance between the belt member and the nip portion forming member is reduced has been widely adopted.

The configuration described in Japanese Patent Application Laid-Open No. 2023-77275 includes a lubricant applying member which applies a lubricant to a heating roller which heats a belt member, and the lubricant is applied to an inner peripheral surface of the belt member from the lubricant applying member via the heating roller. As the lubricant applying member, those to which the lubricant is impregnated in advance, for example, such as a porous organic or inorganic material such as a sponge and a porous ceramic body, and a woven or nonwoven fabric of organic or inorganic fibers such as cloth and polyester fibers is used. In the case of the configuration described in Japanese Patent Application Laid-Open No. 2023-77275, by bringing the lubricant applying member into contact with the heating roller, the lubricant is seeped out and applied to a surface of the heating roller little by little, and the lubricant is further applied from the heating roller to the inner peripheral surface of the belt member.

### SUMMARY

According to an aspect of the present invention, there is provided a fixing device for heating a toner image borne on a recording material and fixing to the recording material, the fixing device comprising: an endless belt member; a rotatable member configured to rotate in contact with an outer peripheral surface of the belt member; a nip portion forming member disposed inside the belt member so as to nip the belt member between itself and the rotatable member and configured to form a nip portion, between itself and the belt member, for nipping and conveying the recording material; a first stretching member in contact with an inner peripheral surface of the belt member and configured to stretch the belt member; a second stretching member in contact with the inner peripheral surface of the belt member on a downstream side of the first stretching member and an upstream side of the nip portion forming member with respect to a rotational direction of the belt member, and configured to stretch the belt member; a heating portion configured to heat the belt member by heating the second stretching member; and a lubricant applying member in contact with the inner peripheral surface of the belt member on the downstream side of the first stretching member and an upstream side of the second stretching member with respect to the rotational direction of the belt member, and configured to apply a lubricant to the inner peripheral surface of the belt member.

Further features of the present invention will become apparent from the following description of exemplary embodiments with reference to the attached drawings.

### BRIEF DESCRIPTION OF THE DRAWINGS

FIG. 1 is a cross-sectional view of an outline configuration of an image forming apparatus according to an Embodiment.

FIG. 2 is a cross-sectional view of an outline configuration of a fixing device according to the Embodiment.

FIG. 3 is a cross-sectional view of an outline configuration of a vicinity of an oil applying roller according to the Embodiment.

FIG. 4 is a schematic view illustrating relationship between the oil applying roller and a steering roller according to the Embodiment.

FIG. 5 is a graph showing relationship between temperature and viscosity of oil.

FIG. 6 is a graph showing relationship between the viscosity of the oil and a film thickness of the oil on a belt.

FIG. 7 is a view for describing measuring positions of a temperature with respect to a rotational direction of a fixing belt.

FIG. 8 is a graph showing relationship between a number of swings of the steering roller and the film thickness of the oil at each position in a longitudinal direction of the fixing belt.

### DESCRIPTION OF THE EMBODIMENTS

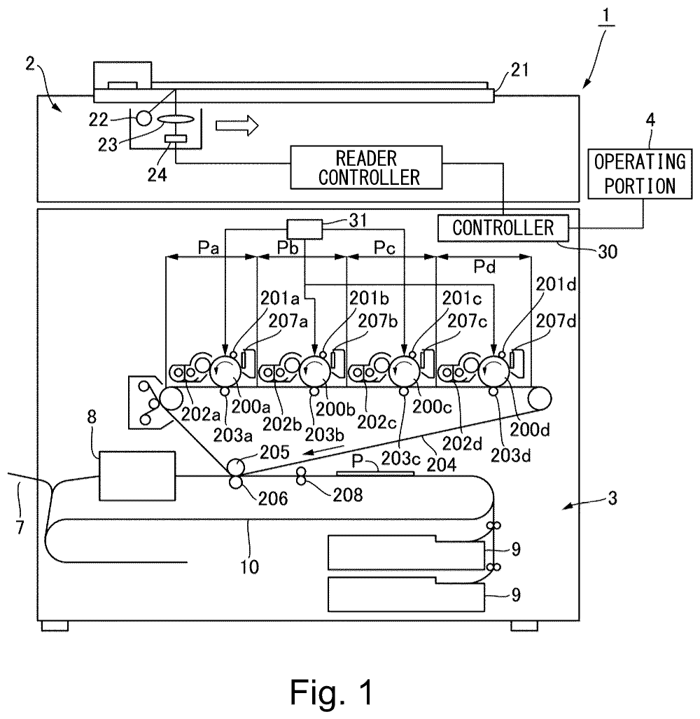

An Embodiment will be described using FIG. 1 through FIG. 8. First, an outline configuration of an image forming apparatus of the present Embodiment will be described using FIG. 1.

### [Image Forming Apparatus]

An image forming apparatus 1 is a full-color printer of an electrophotographic type, which is provided with four image forming portions Pa, Pb, Pc and Pd, which are provided correspondingly to four colors of yellow, magenta, cyan and black. In the present Embodiment, it is configured as a tandem type, in which the image forming portions Pa, Pb, Pc and Pd are disposed along a rotational direction of an intermediary transfer belt 204, which will be described below. The image forming apparatus 1 forms a toner image (image) on a recording material according to an image signal from an image reading portion (original reading apparatus) 2 connected to a main assembly of the image forming apparatus 3 or a host device such as a personal computer communicably connected to the main assembly of the image forming apparatus 3. Examples of the recording material include sheet material such as a paper, a plastic film and cloth.

The image forming apparatus 1 is provided with the image reading portion 2 and the main assembly of the image forming apparatus 3. The image reading portion 2 reads an original placed on an original supporting platen glass 21, light irradiated from a light source 22 is reflected by the original, and an image is formed on a CCD sensor 24 via an optical system member 23 such as a lens. By scanning in a direction of a hollow arrow, such an optical system unit converts the original into an electrical signal data sequence for each line. The image signal obtained by the CCD sensor 24 is sent to the main assembly of the image forming apparatus 3, and an image processing corresponding to each image forming portion, which will be described below, is performed in a control portion 30. In addition, the control portion 30 also receives an external input from an external host device such as a print server as the image signal. The main assembly of the image forming apparatus 3 is provided with the plurality of the image forming portions Pa, Pb, Pc and Pd, and in each image forming portion, image formation is performed based on the image signal described above. That is, the image signal is converted into a laser beam, which is subjected to pulse width modulation (pulse width modulation control) by the control portion 30. A polygon scanner 31 as an exposure device scans the laser beam according to the image signal. And the laser beams are irradiated to photosensitive drums 200a through 200d as image bearing members of each of the image forming portions Pa through Pd.

Incidentally, Pa is the image forming portion for yellow color (Y), Pb is the image forming portion for magenta color (M), Pc is the image forming portion for cyan color (C), and Pd is the image forming portion for black color (Bk), and each forms an image of the corresponding color. Since the image forming portions Pa through Pd are substantially the same, details of the image forming portion Pa for Y will be described below and the description for the other image forming portions will be omitted. In the image forming portion Pa, the toner image is formed on a surface of a photosensitive drum 200a based on the image signal, as described next.

A charging roller 201a as a primary charger charges the surface of the photosensitive drum 200a to a predetermined potential and prepares for an electrostatic latent image formation. By the laser beam from a polygon scanner 31, an electrostatic latent image is formed on the surface of the photosensitive drum 200a, which has been charged to the predetermined potential. A developing unit 202a develops the electrostatic latent image on the photosensitive drum 200a and forms the toner image. A primary transfer roller 203a performs electric discharge from a back surface of the intermediary transfer belt 204, and applies a primary transfer bias having reverse polarity to toner to transfer the toner image on the photosensitive drum 200a onto the intermediary transfer belt 204. For the photosensitive drum 200a after the transfer, the surface thereof is cleaned by a cleaner 207a.

In addition, the toner image on the intermediary transfer belt 204 is conveyed to the next image forming portion, in an order of Y, M, C and Bk, the toner image of each color formed in each image forming portion is transferred sequentially, and an image of the four colors is formed on the surface thereof. And the toner image which has passed through the image forming portion Pd for Bk, which is disposed downstreammost in the rotational direction of the intermediary transfer belt 204, is conveyed to a secondary transfer portion, which is constituted by a secondary transfer roller pair 205 and 206. And in the secondary transfer portion, by a secondary transfer electric field having reverse polarity to the toner image on the intermediary transfer belt 204 being applied, the toner image is secondarily transferred to the recording material.

The recording material is accommodated in a cassette 9, and the recording material fed from the cassette 9 is conveyed to a registration portion 208, which is constituted by a pair of registration rollers, for example, and waits in the registration portion 208. Thereafter, the registration portion 208 conveys, with timing being controlled to align positions of the toner image on the intermediary transfer belt 204 and of the sheet, the recording material to the secondary transfer portion.

The recording material, to which the toner image has been transferred in the secondary transfer portion, is conveyed to a fixing device 8, and in the fixing device 8, by being heated and pressed, the toner image carried on the recording material is fixed to the recording material. The recording material which has passed through the fixing device 8 is discharged onto a discharge tray 7. Incidentally, in a case in which the images are formed on both sides of the recording material, when the transfer and the fixing of the toner image to a first surface (front surface) of the recording material are completed, the front and a back of the recording material are reversed through a reverse conveyance portion 10, the transfer and the fixing of the toner image to a second surface (back surface) of the recording material are performed, and the recording material is stacked on the discharge tray 7.

Incidentally, the control portion 30 performs control of the entire image forming apparatus 1 as described above. In addition, the control portion 30 can set various types of settings etc. based on an input from an operating portion 4, which is provided to the image forming apparatus 1. Such control portion 30 includes a CPU (Central Processing Unit), a ROM (Read Only Memory) and a RAM (Random Access Memory). The CPU performs control of each portion while reading out programs corresponding to control procedures stored in the ROM. In addition, in the RAM, working data and input data are stored, and the CPU performs control with referencing to the data stored in the RAM based on the aforementioned programs, etc.

### [Fixing Device]

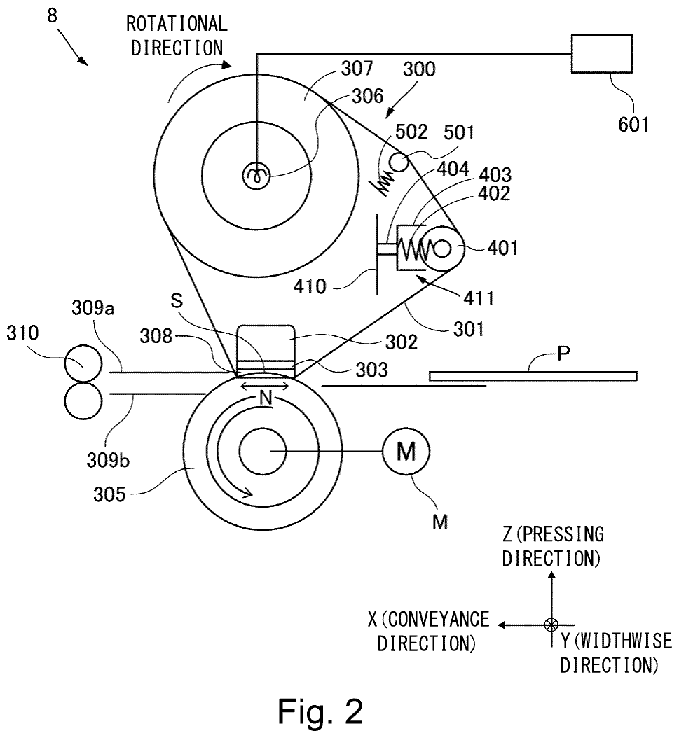

Next, a configuration of the fixing device 8 in the present Embodiment will be described using FIG. 2. FIG. 2 is a cross-sectional view schematically illustrating an outline configuration of the fixing device 8. In the present Embodiment, a fixing device of a belt heating type using an endless belt is adopted. In FIG. 2, an X direction indicates a conveyance direction of a recording material P, a Y direction indicates a widthwise direction crossing (in the present Embodiment, perpendicular to) the conveyance direction of the recording material P, and a Z direction indicates a pressing direction of a pressing roller 305, which will be described below. These are perpendicular to each other. In addition, one side of the widthwise direction (Y direction) is a front side of the image forming apparatus 1 and is a side on which the operating portion 4 is disposed and a user operates, for example. On the other hand, the other side of the widthwise direction is a back side of the image forming apparatus 1.

The fixing device 8 includes a heating unit 300, which includes a fixing belt 301 as an endless rotatable belt member, and the pressing roller 305 as a rotatable member, which is in contact with the fixing belt 301 and forms a nip portion N with the fixing belt 301.

The heating unit 300 includes the fixing belt 301 described above, a fixing pad 303 as a nip portion forming member and a pad member, a stay 302, a heating roller 307 as a first stretching member, a steering roller 401 as a second stretching member, and an oil applying roller 501 as a lubricant supplying member. The pressing roller 305 is also a rotatable driving member, which rotates in contact with an outer peripheral surface of the fixing belt 301 and applies driving force to the fixing belt 301.

The fixing belt 301 has thermal conductivity and heat resistance etc., and has a cylindrical shape of a thin wall. In the present Embodiment, the fixing belt 301 is configured as a three-layer structure, in which a base layer is formed, an elastic layer is formed on an outer periphery of the base layer, and a releasing layer is formed on an outer periphery of the elasticity layer. And, the base layer has a thickness of 80 μm and for material thereof, polyimide resin (PI) is used, the elastic layer has a thickness of 100 μm and for material thereof, silicone rubber is used, and the releasing layer has a thickness of 30 μm and for material thereof, PFA (tetrafluoroethylene perfluoroalkoxyethylene copolymerization resin) as fluorine resin is used. Such fixing belt 301 is stretched by the fixing pad 303, the heating roller 307 and the steering roller 401.

The fixing pad 303 is disposed non-rotatably inside the fixing belt 301 so as to nip the fixing belt 301 between itself and the pressing roller 305. The fixing pad 303 forms the nip portion N, which nips and conveys the recording material between the fixing belt 301 and the pressing roller 305. In the present Embodiment, the fixing pad 303 is a member, which is long along a widthwise direction of the fixing belt 301 (a longitudinal direction crossing a rotational direction of the fixing belt 301, a rotational axis direction of the heating roller 307) and has an approximately plate shape. By the fixing pad 303 being pressed by the pressing roller 305 across the fixing belt 301, the nip portion Nis formed. For material of the fixing pad 303, LCP (liquid crystal polymer) resin is used.

The fixing pad 303 is supported by the stay 302 as a supporting member, which is disposed inside the fixing belt 301. That is, the stay 302 is disposed on an opposite side of the fixing pad 303 to the pressing roller 305 and supports the fixing pad 303. Such stay 302 is a reinforcing member, which is long along the longitudinal direction of the fixing belt 301 and has rigidity, is in contact with the fixing pad 303, and backs up the fixing pad 303. That is, upon the fixing pad 303 being pressed from the pressing roller 305, the stay 302 provides strength to the fixing pad 303 and secures pressing force in the nip portion N.

Between the fixing pad 303 and the fixing belt 301, a lubricated sheet 308, of which a front surface is coated by PTFE (polytetrafluoroethylene), and a silicone oil S (hereinafter, referred to as oil S) as a lubricant are interposed, so that the fixing belt 301 slides smoothly against the fixing pad 303. For the lubricant, the silicone oil is suitably used in terms of heat resistance, etc., and the silicone oil having various viscosities are used depending on use conditions. In the present Embodiment, since those with too high viscosity is poor in flowability during application, for the oil, those with a viscosity of 1000 cSt is used. Examples of such oil include dimethyl silicone oil, amino-modified silicone oil and fluorine-modified silicone oil, however, it is not particularly limited to these.

The lubricated sheet 308 is formed by coating the PTFE on a front surface of a polyimide base material having a thickness of 70 μm. Incidentally, since the lubricated sheet 308 is disposed to improve sliding property between the fixing pad 303 and the fixing belt 301, it is possible to substitute by applying a coating, etc., which improves the sliding property, to a surface layer of the fixing pad 303 instead of the lubricated sheet 308.

The heating roller 307 is disposed inside the fixing belt 301, and stretches the fixing belt 301 with the fixing pad 303 and the steering roller 401. The heating roller 307 is formed of metal such as aluminum and stainless steel into a cylindrical shape, and inside the heating roller 307, a halogen heater 306 as a heating portion for heating the fixing belt 301 is provided. And the heating roller 307 is heated to a predetermined temperature by the halogen heater 306. The halogen heater 306 is heated by electric power being supplied from an electric power supplying portion 601.

In the present Embodiment, the heating roller 307 is formed of, for example, a pipe made of stainless steel with a thickness of 1 mm. In addition, the halogen heater 306 may be one or a plurality of the halogen heaters 306 may be provided. In the present Embodiment, in order to meet a recent need for energy saving, the electric power which can be used by the fixing device 8, i.e., by the halogen heater 306, is also reduced. Specifically, the electric power used by the halogen heater 306 is 1400 W or less. Incidentally, the heating portion which heats the heating roller 307 is not limited to the halogen heater, but it may be other heaters capable of heating the heating roller 307, for example, such as a carbon heater. The fixing belt 301 is heated by the heating roller 307, which is heated by the halogen heater 306, and based on temperature detection by an unshown thermistor, is controlled at a predetermined target temperature depending on a type of the recording material.

The steering roller 401 is disposed inside the fixing belt 301, stretches the fixing belt 301 with the fixing pad 303 and the heating roller 307, and is rotated driven by the fixing belt 301. In the present Embodiment, the steering roller 401 is in contact with an inner peripheral surface of the fixing belt 301 on a downstream side of the heating roller 307 and an upstream side of the fixing pad 303 with respect to the rotational direction of the fixing belt 301, and stretches the fixing belt 301. In addition, a rotational axis of the steering roller 401 is inclinably disposed to a direction parallel to the rotational axis direction (a widthwise direction, a longitudinal direction) of the heating roller 307, and controls a position (shifted position) of the fixing belt 301 with respect to the rotational axis direction of the heating roller 307 by being inclined. In other words, the steering roller 401 is a roller for adjusting the position of the fixing belt 301 by being inclined relative to the heating roller 307 so that the fixing belt 301 is positioned within a predetermined range in the widthwise direction of the fixing belt 301.

That is, the steering roller 401 has a rotation center at a center or one end portion in the rotational axis direction (longitudinal direction) of the steering roller 401, and by being swung about the rotation center, the steering roller 401 is inclined relative to the longitudinal direction of the heating roller 307. By this, a tension difference between one side and the other side in the longitudinal direction of the fixing belt 301 is generated, and the fixing belt 301 is moved in the longitudinal direction. Due to an outer diameter accuracy of the stretching roller and an alignment accuracy between each roller, etc., the fixing belt 301 may be shifted to one of the end portions during rotation. Therefore, such shift is controlled by the steering roller 401. Incidentally, the steering roller 401 may be swung by a driving source such as a motor, or may have a configuration swung by automatic center alignment.

The steering roller 401 in the present Embodiment will be described in more detail. The steering roller 401 is rotatably supported via a steering supporting portion 411 to a frame 410 of the heating unit 300. The frame 410 supports the heating roller 307, the stay 302 and the fixing pad 303. The steering supporting portion 411 is supported rotatably about a rotation shaft 404 to the frame 410. By the steering supporting portion 411 being rotated to the frame 410 of the heating unit 300 with the rotation shaft 404 as a fulcrum, the steering roller 401 is inclined.

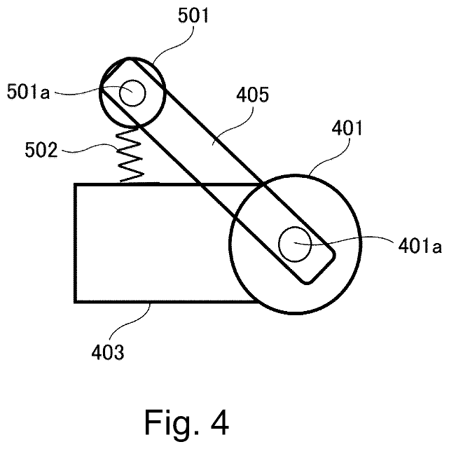

Incidentally, as shown in FIG. 4 described below, the steering supporting portion 411 includes a steering holding portion 403 which holds a rotational shaft 401a of the steering roller 401 to the frame 410, and a swing arm 405 connected to the rotational shaft 401a of the steering roller 401 and swingably supports the oil applying roller 501, which will be described below, to the rotational shaft 401a of the steering roller 401.

In addition, in a case of the present Embodiment, the steering roller 401 is urged toward the fixing belt 301 by an urging spring 402 as a steering urging portion, and is also a tension roller which applies a predetermined tension to the fixing belt 301. That is, by the urging spring 402 which is supported by the steering holding portion 403, the steering roller 401 is urged toward the fixing belt 301. The urging spring 402 is disposed between the steering roller 401 and the steering holding portion 403, and urges the steering roller 401 toward the inner peripheral surface of the fixing belt 301.

The oil applying roller 501 is in contact with the inner peripheral surface of the fixing belt 301 and applies a lubricant to the inner peripheral surface of the fixing belt 301. In the present Embodiment, as described in detail below, the oil applying roller 501 is disposed on the downstream side of the heating roller 307 and the upstream side of the steering roller 401 with respect to the rotational direction of the fixing belt 301.

The pressing roller 305 rotates in contact with the outer peripheral surface of the fixing belt 301 and applies the driving force to the fixing belt 301. In the present Embodiment, the pressing roller 305 is a roller in which an elasticity layer is formed on an outer periphery of a shaft thereof and a release layer is formed on an outer periphery thereof. In addition, for the shaft, stainless steel with a diameter of 72 mm is used, for the elasticity layer, conductive silicone rubber with a thickness of 8 mm is used, and for the release layer, PFA (tetrafluoroethylene perfluoroalkoxyethylene copolymerization resin) as fluorine resin with a thickness of 100 μm is used, respectively. The pressing roller 305 is rotatably supported by a pressing arm which is movable to a fixing frame (not shown) of the fixing device 8, a gear is fixed to one end portion thereof, and the pressing roller 305 is connected to a motor M as a pressing roller driving source via the gear, and is rotationally driven.

The fixing device 8 configured in this manner, in the nip portion N formed between the fixing belt 301 and the pressing roller 305, heats the toner image while nipping and conveying the recording material P which carries the toner image. Then, the toner image is fixed to the recording material P. Therefore, it is necessary for the fixing device 8 to serve both of a function for applying heat and pressure and a function for conveying the recording material P. The pressing roller 305 is pressed against the fixing pad 303 across the fixing belt 301 by an unshown driving source. In the present Embodiment, pressing force in the nip portion N (NF) during image formation is 1600 N, and a length of the nip portion N in the X direction (conveyance direction) is set to 24.5 mm, and a length in the Y direction (widthwise direction) is set to 326 mm.

In addition, in a downstream of the nip portion N in the conveyance direction of the recording material P, a discharging roller pair 310, a separating plate 309a, and a lower separating guide 309b, which are for discharging the recording material P which has passed through the nip portion N out of the fixing device 8, are disposed. The separating plate 309a is disposed in the downstream side of the nip portion N in the conveyance direction of the recording material and above the nip portion N in a vertical direction, and a tip thereof is closely opposing in a vicinity of the nip portion N of the fixing belt 301. And the separating plate 309a separates the recording material P which has passed through the nip portion N.

The lower separating guide 309b is disposed in the downstream side of the nip portion N in the conveyance direction of the recording material and below the nip portion N in the vertical direction, and a tip thereof is closely opposing in a vicinity of the nip portion N of the pressing roller 305. And the lower separating guide 309b separates, in a case in which the recording material P sticks to the pressing roller 305, the recording material P from the pressing roller 305. In addition, the lower separating guide 309b supports a lower surface of the recording material P which has been discharged from the nip portion N, and guides the recording material P to the discharging roller pair 310. The discharging roller pair 310 discharges the recording material P, which has been discharged from the nip portion N, out of the fixing device 8.

### [Oil Applying Roller]

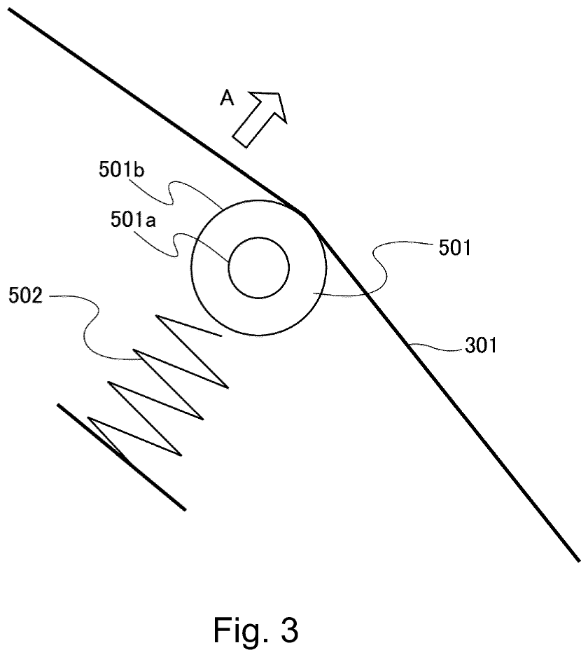

FIG. 3 is an outline view of a periphery of the oil applying roller 501. The oil applying roller 501 as a lubricant applying roller is constituted by a core metal portion 501a as a shaft portion and an oil impregnated layer 501b as a lubricant impregnated layer which is provided around the core metal portion 501a. The core metal portion 501a is a roller shaft portion made of material, for example, such as aluminum, iron and stainless steel. The oil impregnated layer 501b is formed by winding a nonwoven fabric, which is impregnated with the same oil as the silicone oil applied in advance to the inner surface of the fixing belt 301, around the core metal portion 501a. However, the oil impregnated layer 501b is not limited this, but may be, for example, a porous organic or inorganic material such as a sponge and a porous ceramic body, and a woven organic or inorganic fabric of fibers such as cloth and polyester fibers. That is, the oil impregnated layer 501b may be one of the nonwoven fabric impregnated with the lubricant, the porous material impregnated with the lubricant or the woven fabric of fibers impregnated with the lubricant. The oil applying roller 501 is urged toward the inner peripheral surface of the fixing belt 301 (a direction of an arrow A) by a spring 502 as an urging portion.

FIG. 4 is a view illustrating relationship between the oil applying roller 501 and the steering roller 401. The oil applying roller 501 is supported by the steering supporting portion 411, which supports the steering roller 401. The steering supporting portion 411 includes, as described above, the steering holding portion 403 which holds the rotational shaft 401a of the steering roller 401 and the swing arm 405. One end portion of the swing arm 405 is connected to the rotational shaft 401a of the steering roller 401, and the other end portion is connected to the core metal portion 501a, which is the shaft portion of the oil applying roller 501. By this, the swing arm 405 swingably supports the oil applying roller 501 to the rotational shaft 401a of the steering roller 401.

In addition, the spring 502 is provided between the steering holding portion 403 and the oil applying roller 501, and urges the oil applying roller 501 toward the inner peripheral surface of the fixing belt 301. The oil applying roller 501 is urged to the fixing belt 301 by the spring 502 at about from 800 to 1500 gf. With the configuration in this manner, it becomes possible for the oil applying roller 501 to follow the action of the fixing belt 301 associated with the shift control by the steering roller 401.

### [Arrangement Position of the Oil Applying Roller]

As shown in FIG. 2, the oil applying roller 501 is disposed on the downstream side of the heating roller 307 and the upstream side of the steering roller 401 with respect to the rotational direction of the fixing belt 301 in a state urged toward the inner peripheral surface of the fixing belt 301 by the spring 502 so as to be in contact with the inner peripheral surface of the fixing belt 301. Reasons for disposing the oil applying roller 501 at this arrangement position include the following two.

A first reason is in terms of an amount of heat applied to the oil which is impregnated in the oil applying roller 501. In the nip portion N, a temperature of the fixing belt 301 required to melt and fix the toner onto the recording material is 140° C., so that a temperature of the heating roller 307 need to be set to 200° C. In a case in which it is configured that the oil is applied to the heating roller 307 by bringing the oil applying roller 501 into contact with the heating roller 307, the amount of heat of 200° C. is applied to the oil. In this case, the amount of the heat applied to the oil is excessive, and the oil may have too low viscosity. As a result, a phenomenon, in which the oil leaks from the end portions in the longitudinal direction of the heating roller 307 and/or of the fixing belt 301, may occur.

The second reason is in terms of an applied amount of the oil, which is applied to the fixing belt 301 from the oil applying roller 501. In order to prevent such an oil leakage as described above from occurring, it may be conceivable to dispose the oil applying roller 501 on the fixing belt 301 having a relatively low temperature, however, the fixing belt 301 has different temperatures depending on positions in the rotational direction. The temperature of the fixing belt 301, which is heated by the heating roller 307, is gradually getting low due to release of heat to an atmosphere along with the rotation of the fixing belt 301. In addition, at the position of the fixing pad 303, since the heat is taken by the toner and the recording material P, the temperature of the fixing belt 301 drops significantly.

Here, as for the oil impregnated in the oil applying roller 501, the higher the temperature, the lower the viscosity thereof, and so that the flowability is increased, and it becomes possible to increase the applied amount of the oil to the fixing belt 301. Therefore, in a case of bringing the oil applying roller 501 into contact with the fixing belt 301 at a position where the temperature of the fixing belt 301 is low, the viscosity of the oil gets higher and the flowability thereof is decreased, and the applied amount of the oil to the fixing belt 301 is decreased. When the applied amount of the oil to the fixing belt 301 is decreased, the oil supplied to the sliding portion between the fixing belt 301 and the fixing pad 303 is decreased, and sliding resistance between the fixing belt 301 and the fixing pad 303 is increased. When the sliding resistance is increased, image defect may occur during fixing of the toner image and/or a service life of the fixing belt 301 may be shortened by the inner peripheral surface of the fixing belt 301 being scraped.

Therefore, in the present Embodiment, the oil applying roller 501 is disposed, with respect to the rotational direction of the fixing belt 301, at a position just behind on the downstream side of the heating roller 307, where the temperature of the fixing belt 301 is high. By this, the flowability of the oil is increased, and it becomes possible to increase the applied amount of the oil to the fixing belt 301. When it becomes possible to increase the applied amount of the oil applied to the fixing belt 301, it becomes possible to supply a sufficient amount of the oil to the sliding portion between the fixing belt 301 and the fixing pad 303. In addition, since the temperature of the fixing belt 301 at the position where the oil applying roller 501 is in contact is sufficiently lower than the temperature of the fixing belt 301 at the position where the heating roller 307 is in contact, it becomes possible to suppress the supply of the excessive amount of heat to the oil. As a result, it becomes possible to suppress that, by the viscosity of the oil getting too low, the oil leaks from the end portions in the longitudinal direction of the fixing belt 301.

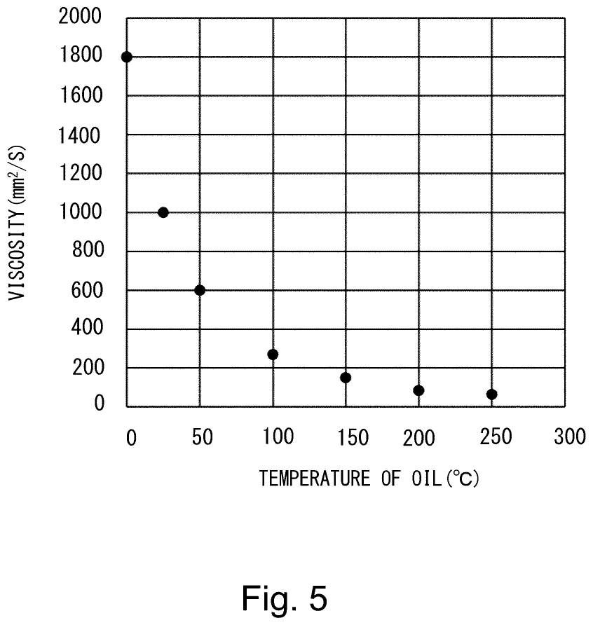

FIG. 5 is a graph showing relationship between the temperature and the viscosity of the oil used in the present Embodiment. In general, as shown in FIG. 5, the higher the oil temperature, the lower the oil viscosity. Since the oil applying roller 501 is in contact with the fixing belt 301, the temperature of the oil impregnated in the oil applying roller 501 and the temperature of the fixing belt 301 can be considered to have a proportional relationship. In other words, the higher the temperature of the fixing belt 301, the lower the oil viscosity.

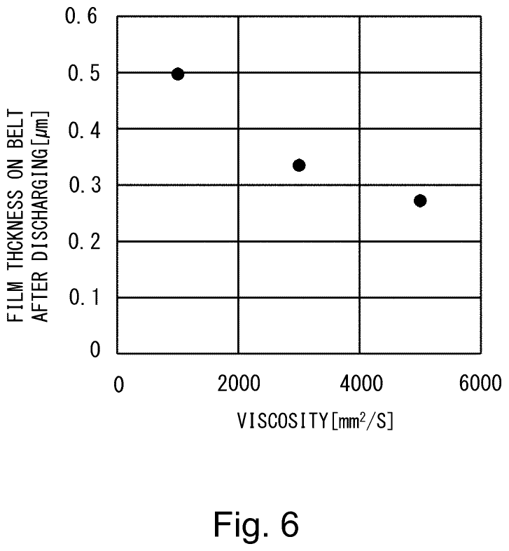

FIG. 6 is a graph showing results of an experiment in which relationship between the oil viscosity and an oil film thickness on the fixing belt 301 after the oil is discharged from the oil applying roller 501 to the fixing belt 301 (film thickness on the belt after discharge) is examined. It means that the thicker the oil film thickness on the fixing belt 301, the more a discharged amount of the oil from the oil applying roller 501. In this experiment, the oil with three types of viscosities of 1000 mm²/S, 3000 mm²/S, and 5000 mm²/S are used at a room temperature of 25° C. In the experiment, these three types of the oils are discharged from the oil applying roller 501 to the fixing belt 301, the temperature of the heating roller 307 is set to 160° C., and the fixing belt 301 is rotated for sixty minutes. In FIG. 6, the oil film thickness on the fixing belt 301 at this time is shown. According to the relationship shown in FIG. 5 and FIG. 6, it is found that the higher the temperature of the fixing belt 301 is, the lower the oil viscosity becomes, and the lower the oil viscosity is, the thicker the oil film thickness on the fixing belt 301 becomes. That is, it is found that the higher the temperature of the fixing belt 301 is, the more the discharged amount of the oil from the oil applying roller 501 to the fixing belt 301 becomes.

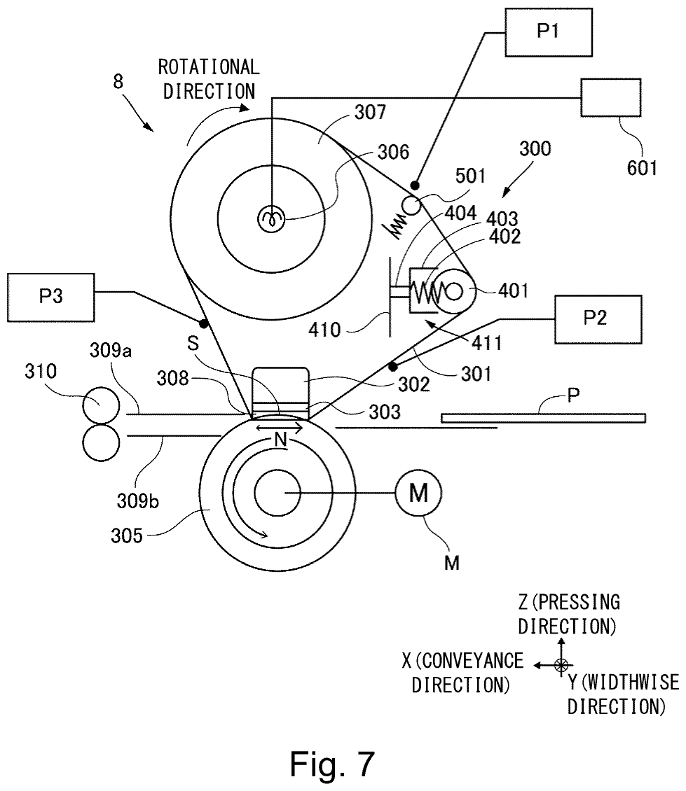

Next, an experiment in which differences of the temperatures depending on positions of the fixing belt 301 are examined will be described using FIG. 7. In the experiment, while the fixing device 8 is driven, the temperature of the fixing belt 301 is measured at a plurality of locations with respect to the rotational direction of the fixing belt 301. FIG. 7 shows the positions at which the temperature of the fixing belt 301 is measured in the experiment. The measurement of the temperature at each position is performed in a state in which, in the image forming apparatus 1 provided with the fixing device 8, the image is being formed onto the recording material P of 81 g/m². At this time, temperature control of the fixing device 8 is performed by executing heating control of the halogen heater 306 so that the unshown thermistor, which is disposed in contact with the heating roller 307, is at a predetermined temperature. The predetermined temperature is a temperature determined in advance, and in the present experiment, is set to 200° C.

The positions for the temperature measurement of the fixing belt 301 are, with respect to the rotational direction of the fixing belt 301, a P1 position, which is on the downstream side of the heating roller 307 and the upstream side of the steering roller 401, a P2 position, which is on the downstream side of the steering roller 401 and the upstream side of the fixing pad 303, and a P3 position, which is on the downstream side of the fixing pad 303 and the upstream side of the heating roller 307. Results of the temperature measurement at each position are shown in Table 1.

TABLE 1

| Belt position | Belt temperature (° C.) |
|---|---|
| P1 | 155 |
| P2 | 147 |
| P3 | 140 |

From Table 1, with respect to the rotational direction of the fixing belt 301, the temperature is 155° C. and highest at the P1 position, which is just behind on the downstream side of the heating roller 307, however, the temperature is lowered to 147° C. at the P2 position due to the release of the heat to an atmosphere. In addition, at the P3 position, due to a temperature decrease by the heat being taken by the toner and the recording material P in the nip portion N and the release of the heat to an atmosphere, the temperature drops further to 140° C.

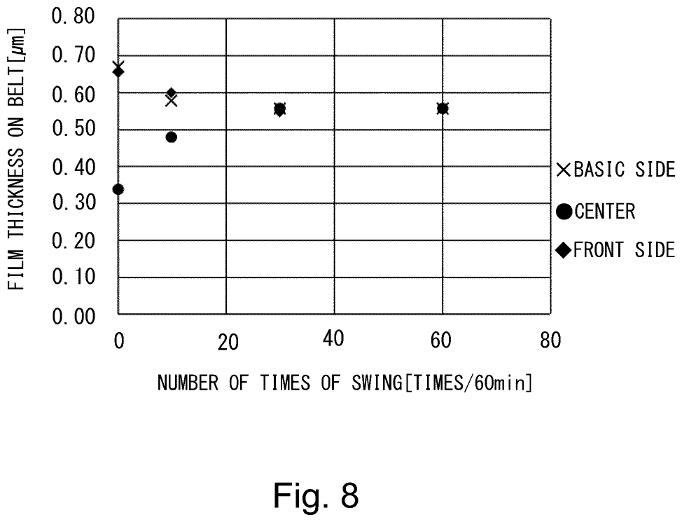

Next, a reason for disposing the oil applying roller 501 at the position of the present Embodiment will be described in relation to the steering roller 401. FIG. 8 is a graph showing results measuring the oil film thickness on the fixing belt 301 (oil film thickness on the belt), in a case in which the oil applying roller 501 is installed at the position of the present Embodiment, and a number of swings of the steering roller 401 per unit time (times/60 minutes) is varied, on a back side, at a center, and on a front side in the longitudinal direction of the fixing belt 301, respectively. From FIG. 8, it is found that, as the number of swings of the steering roller 401 is increased, it becomes possible to distribute the oil evenly in the longitudinal direction of the fixing belt 301.

That is, with respect to the rotational direction of the fixing belt 301, by disposing the oil applying roller 501 on the upstream side of the steering roller 401, it becomes possible to supply the oil evenly in the longitudinal direction of the nip portion N, which is formed between the fixing belt 301 and the pressing roller 305.

Here, in each of the cases in which the oil applying roller 501 is disposed at the P1 position, the P2 position and the P3 position shown in FIG. 7 described above, results measuring the oil film thickness on the fixing belt 301 are shown in Table 2.

TABLE 2

Installed position of
the oil applying roller

| | P1 | P2 | P3 |
|---|---|---|---|
| Oil film thickness on the belt [μm] | 0.56 | 0.51 | 0.44 |

As clearly seen from Table 2, the results show that, in an order that the temperature of the fixing belt 301 is high, the oil film thickness is thicker. The results shows that at the P1 position, which is the position of the present Embodiment, the discharged amount is increased about 10% compared to the P2 position, and the discharged amount is increased about 27% compared to the P3 position.

As such, in the present Embodiment, the oil applying roller 501 is disposed so as to be in contact with the inner peripheral surface of the fixing belt 301 on the downstream side of the heating roller 307 and the upstream side of the steering roller 401 with respect to the rotational direction of the fixing belt 301. Therefore, it becomes possible to supply the oil appropriately between the fixing pad 303 and the fixing belt 301. That is, since the oil applying roller 501 is not brought into contact with the heating roller 307 but is brought into contact with the inner peripheral surface of the fixing belt 301 on the downstream side of the heating roller 307, it becomes possible to suppress that the amount of heat applied to the oil becomes excessive and to suppress the low viscosity of the oil. As a result, it becomes possible to suppress that the oil leaks from the end portions in the longitudinal direction of the fixing belt 301, and without increasing a size of the oil applying roller 501 in order to increase an impregnated volume of the oil in the oil applying roller 501, it becomes possible to supply an appropriate amount of the oil between the fixing pad 303 and the fixing belt 301.

In addition, by the oil applying roller 501 being positioned on the downstream side of the heating roller 307 and the upstream side of the steering roller 401 with respect to the rotational direction of the fixing belt 301, it becomes possible to apply the oil from the oil applying roller 501 to the fixing belt 301 at the position in which the temperature of the fixing belt 301 is relatively high. As described above, when the temperature of the oil is too low, the flowability of the oil is decreased and the applied amount of the oil to the fixing belt 301 is decreased. Therefore, in the present Embodiment, by disposing the oil applying roller 501 on the downstream side of the heating roller 307 and the upstream side of the steering roller 401, lowering of the temperature of the oil is suppressed and the applied amount of the oil to the fixing belt 301 is secured. As such, when the applied amount of the oil can be secured, it becomes possible to supply an appropriate amount of the oil between the fixing pad 303 and the fixing belt 301.

In addition, in the present Embodiment, the oil applying roller 501 is supported by the steering supporting portion 411, which supports the steering roller 401. Therefore, the oil applying roller 501 is swung with the steering roller 401, so that it becomes possible to perform the oil application from the oil applying roller 501 to the fixing belt 301 evenly with respect to the longitudinal direction of the fixing belt 301. As a result, between the fixing pad 303 and the fixing belt 301, it becomes possible to supply the oil which is applied evenly with respect to the longitudinal direction.

As described above, according to the present Embodiment, it becomes possible to supply the oil, of which the amount is appropriate and the applied amount is even in the longitudinal direction, between the fixing pad 303 and the fixing belt 301. Therefore, it becomes possible to suppress that the sliding resistance between the fixing pad 303 and the fixing belt 301 is increased, and to suppress the occurrence of the image defect and that the inner peripheral surface of the fixing belt 301 is scraped.

### Other Embodiments

In the present Embodiment described above, the configuration using the pressing roller as the rotatable driving member is described. However, the rotatable driving member may be an endless belt which is stretched by a plurality of stretching rollers and driven by any of the stretching rollers. In addition, in the present Embodiment described above, in order to form the nip portion, the pressing roller as the rotatable driving member is pressed toward the belt, however, it may be a configuration in which the belt is pressed toward the rotatable driving member. Furthermore, in the present Embodiment described above, the configuration using the fixing pad as the nip portion forming member is described, however the nip portion forming member may be a roller.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-095147 filed on Jun. 12, 2024, which is hereby incorporated by reference herein in its entirety.

What is claimed is:

1. A fixing device for heating a toner image borne on a recording material and fixing to the recording material, the fixing device comprising:
an endless belt member;
a rotatable member configured to rotate in contact with an outer peripheral surface of the belt member;
a nip portion forming member disposed inside the belt member so as to nip the belt member between itself and the rotatable member and configured to form a nip portion, between itself and the belt member, for nipping and conveying the recording material;
a first stretching member in contact with an inner peripheral surface of the belt member and configured to stretch the belt member;
a second stretching member in contact with the inner peripheral surface of the belt member on a downstream side of the first stretching member and an upstream side of the nip portion forming member with respect to a rotational direction of the belt member, and configured to stretch the belt member;
a heating portion configured to heat the belt member by heating the second stretching member; and
a lubricant applying member in contact with the inner peripheral surface of the belt member on the downstream side of the first stretching member and an upstream side of the second stretching member with respect to the rotational direction of the belt member, and configured to apply a lubricant to the inner peripheral surface of the belt member.

2. The fixing device according to claim 1, further comprising an urging portion configured to urge the lubricant applying member toward the inner peripheral surface of the belt member.

3. The fixing device according to claim 1, wherein the lubricant applying member is a lubricant applying roller in which a shaft portion and, around the shaft portion, a lubricant impregnated layer are provided.

4. The fixing device according to claim 3, wherein the lubricant impregnated layer is one of a nonwoven fabric impregnated with the lubricant, a porous material impregnated with the lubricant or a woven fabric of fibers impregnated with the lubricant.

5. The fixing device according to claim 1, wherein the first stretching member is a heating roller including the heating portion inside thereof.

6. The fixing device according to claim 5, wherein the second stretching member is a steering roller of which a rotational axis is inclinably disposed to a direction parallel to a rotational axis direction of the heating roller and configured to control a position of the belt member with respect to the rotational axis direction of the heating roller by being inclined.

7. The fixing device according to claim 6, further comprising:
a frame configured to support the heating roller and the nip portion forming member; and
a steering supporting portion rotatably supported to the frame and configured to support the steering roller,
wherein the lubricant applying member is supported by the steering supporting portion.

8. The fixing device according to claim 7, wherein the steering supporting portion includes a steering holding portion configured to hold a rotational shaft of the steering roller to the frame, and a swing arm connected to the rotational shaft of the steering roller and configured to swingably support the lubricant applying member to the rotational shaft of the steering roller, and
further comprising an urging portion provided between the steering holding portion and the lubricant applying member and configured to urge the lubricant applying member toward the inner peripheral surface of the belt member.

9. The fixing device according to claim 6, further comprising a steering urging portion configured to urge the steering roller toward the belt member,
wherein the steering roller applies a tension to the belt member.

10. The fixing device according to claim 1, wherein the nip portion forming member is a pad member.
